(19) United States
(12) Patent Application Publication
(10) Pub. No.: US 2024/0412905 A1
(43) Pub. Date: Dec. 12, 2024

(54) Process for the Production of Nano-Coated Ferromagnetic Materials

(71) Applicant: Politecnico Di Torino, Torino (TO) (IT)

(72) Inventors: Emir POŠKOVIC, Novi Ligure (IT); Federico CAROSIO, Alessandria (IT); Fausto FRANCHINI, Rocca Susella (IT); Luca FERRARIS, Alessandria (IT); Marco ACTIS GRANDE, Cuneo (IT)

(21) Appl. No.: 18/701,300

(22) PCT Filed: Oct. 17, 2022
(86) PCT No.: PCT/IB2022/059936

§ 371 Date: Apr. 15, 2024

(30) Foreign Application Priority Data
Oct. 18, 2021 (IT) 102021000026681

(51) Int. Cl. H01F 1/26; H01F 1/33

(52) U.S. Cl. CPC H01F 1/26; H01F 1/33

(57) ABSTRACT

A method for the production of a ferromagnetic material includes a first step wherein one or more nanometric functional coatings are deposited on a plurality of ferromagnetic particles and a second step wherein the coated ferromagnetic particles are consolidated to obtain the ferromagnetic material. The deposition of one or more functional coatings includes immersing the ferromagnetic particles in a first solution or suspension including a first reagent having a first (positive or negative) electrostatic charge or having polar groups (carboxylic acids, hydroxyl groups, etc.). The ferromagnetic particles immersed in the first solution or suspension are mixed for a predetermined time period and then immersed in a washing liquid, from which they are subsequently separated. The ferromagnetic particles are immersed in a second solution or suspension including a second reagent having a second electrostatic charge with a sign opposite to that of the first one or capable of interacting with the polar groups of the first reagent.

### BACKGROUND OF THE DISCLOSURE

### 1. The Field of the Disclosure

The present invention relates to a process for the production of nanocoated ferromagnetic materials. In particular, the present invention discloses a process for the production of magnetic materials. Magnetic materials are generally classified as either soft or hard.

### 2. The Relevant Technology

One particular type of soft magnetic materials created starting from ferromagnetic powders is also known as Soft Magnetic Composites (also referred to as SMC materials in the present description). Usually, but non exclusively, such materials are used in electric machines comprising latest-generation magnetic circuits, which can hardly be made by using traditional methods. SMC materials can also be used for making signal and power inductors, EMI filters, and several types of sensors.

The SMC materials known in the art are generally composed of a plurality of ferromagnetic particles (also referred to as ferromagnetic powder in the present description), wherein each ferromagnetic particle is characterized in that it is electrically insulated from the other ones by an insulating material of organic or inorganic nature. International patent application WO2006135324A1 and patent U.S. Pat. No. 6,485,579B1 describe two exemplary methods for the production of SMC materials.

According to techniques known in the art, SMC materials are produced by consolidating a plurality of ferromagnetic particles through the use of a binding element. In addition to keeping the ferromagnetic particles together, the binding elements used for the production of SMC materials must necessarily be characterized by dielectric properties in order to electrically insulate each ferromagnetic particle.

The same production method is also applicable to hard ferromagnetic materials, i.e., those having a broad hysteresis cycle and high values of saturation induction and coercive field. In this case, the produced materials do not fall within the SMC category.

### SUMMARY OF THE DISCLOSURE

In the course of the present description, the term powder ferromagnetic material (also generally defined as ferromagnetic material) will refer without distinction to both soft ferromagnetic materials and hard ferromagnetic materials.

The binding elements used in the processes for the production of powder ferromagnetic materials known in the art may be either organic (e.g., thermoplastic or thermosetting polymers, etc.) or inorganic (e.g., oxides, glasses, ceramics, semiconductor metals, etc.). According to techniques known in the art, the ferromagnetic particles are usually consolidated by adding binding material to the ferromagnetic particles and by mixing the compound thus obtained.

Such mixture is generally subjected to a pressing operation and then to a heat treatment capable of giving the powder electromagnetic material its final shape and mechanical characteristics.

The proportion, physical properties and process according to which such binding element is used for consolidating the ferromagnetic particles directly affect some fundamental characteristics of the finished product (i.e. the finished material and component). For example, the percentage of such agent relative to the ferromagnetic powder and the homogeneity with which the binding element is distributed within the ferromagnetic material directly affect the mechanical and magnetic properties of the finished material; also, the amount and physical properties of the binding element are directly reflected in the material's macroscopic electric resistivity, which, for any undesired effects caused by parasite currents to be reduced, must fall within a predetermined range of values. However, the presence of large quantities of non-magnetic binding agent between the particles of ferromagnetic powder adversely affects the global magnetic characteristics, influencing the normal magnetization curve and the energetic efficiency of the finished material. Therefore, one of the problems related to the production of powder ferromagnetic materials according to the techniques currently known in the art concerns the selection of the binding material and the amount thereof, as well as the choice of the process to be used for consolidating the ferromagnetic particles; in fact, the final properties of the materials produced by means of the techniques known in the art are necessarily subject to several trade-offs as to the balance of their magnetic, energetic and mechanical properties.

Furthermore, another problem suffered by the prior art concerns the temperature of the heat treatment. In general, the treatment temperature depends on the type of binding agent used in the mixture, and the heat treatment may sometimes be used as an annealing treatment and/or as a treatment for relieving residual stresses in the ferromagnetic powder. As the temperature increases, the residual mechanical stresses caused by the various processing steps (i.e., mixing and pressing) will relax, resulting in considerable advantages as to the magnetic and energetic characteristics of the final material. However, excessively high temperatures will tend to deteriorate the binding element, causing its mechanical and dielectric performance to be degraded.

It is therefore one object of the present invention to provide a method for the production of a powder ferromagnetic material which can overcome the drawbacks of the prior art. In particular, it is one object of the present invention to provide a method for the production of a powder ferromagnetic material characterized by a uniform and homogeneous distribution of ferromagnetic particles and binding element, which can be controlled and modified directly by the production process itself. It is another object of the present invention to provide a method for the production of a powder ferromagnetic material characterized by a ratio between the quantity of ferromagnetic particles and the quantity of binding material which is higher than that obtainable with prior-art techniques. It is a further object of the present invention to provide a method for the production of a ferromagnetic material capable of withstanding a heat treatment process characterized by temperatures higher than those which could be used in the prior art.

Lastly, the present invention provides a method for the production of a powder ferromagnetic material wherein the binding element may comprise an organic component and an inorganic component.

### BRIEF DESCRIPTION OF THE DRAWINGS

The above-mentioned objects are achieved by the present invention through a method for the production of a ferromagnetic material incorporating the features set out in the appended claims, which are an integral part of the present description. Further objects, features and advantages of the present invention will become apparent in light of the following detailed description and of the annexed drawings, provided herein merely by way of non-limiting example, wherein:

FIG. 1 shows a block diagram of the method for the production of a ferromagnetic material according to the present invention;

FIG. 2 shows a block diagram of one embodiment of the method for the production of a ferromagnetic material according to the present invention;

FIG. 3 shows a block diagram of one embodiment of the method for the production of a ferromagnetic material according to the present invention;

FIG. 4 shows a block diagram of one embodiment of the process of consolidating the ferromagnetic particles;

FIG. 5 schematically shows an exemplary embodiment of the method for the production of a ferromagnetic material according to the present invention.

### DETAILED DESCRIPTION OF THE PREFERRED EMBODIMENTS

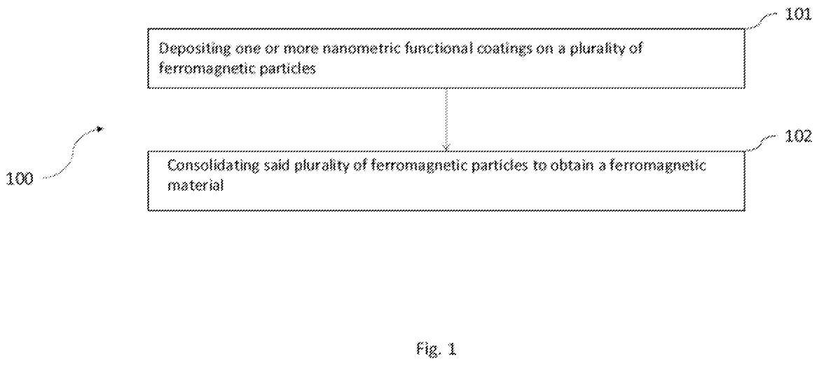

Referring now to the annexed drawings, in FIG. 1 reference numeral 100 designates as a whole a block diagram of the method 100 for the production of a ferromagnetic material according to the present invention.

The method 100 for the production of a ferromagnetic material according to the present invention starts with a surface modification of the single ferromagnetic particles, whereon one or more nanometric functional coatings (also referred to as layers in the course of the present description) are deposited. As shown in FIG. 1, step 101 consists of depositing one or more nanometric functional coatings on a plurality of ferromagnetic particles.

The method 100 for the production of ferromagnetic materials according to the present invention subsequently comprises a step 102 wherein said plurality of ferromagnetic particles coated with one or more nanometric functional coatings are consolidated to obtain a finished ferromagnetic material; step 102 can be carried out by means of one or more powder metallurgy processes known in the art.

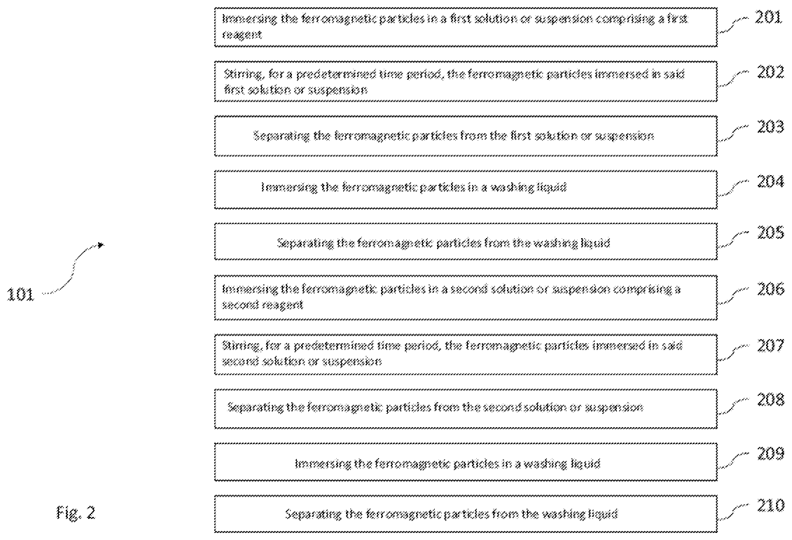

FIG. 2 shows in detail one embodiment of step 101 of the method 100 for the production of a ferromagnetic material according to the present invention. In particular, the process of coating the ferromagnetic particles comprises immersing 201 the ferromagnetic particles in a first solution or suspension comprising a first reagent; according to one aspect of the present invention, the first reagent is such as to be characterized by a first (positive or negative) electrostatic charge. Aiming at optimizing the process of depositing a coating of the first reagent on the surface of the ferromagnetic particles, the present invention may optionally comprise a step 202 wherein the ferromagnetic particles immersed in the first solution or suspension are stirred for a predetermined time period. The stirring process 202 may be carried out either mechanically or by means of ultrasounds or a rotating magnetic field.

At the end of the stirring process 202, the particles are optionally separated 203 from the first solution (e.g., by centrifugation or by means of a static or rotating magnetic field), optionally immersed 204 in a washing liquid (e.g., water, an organic solvent, polar solvents, or mixtures thereof), and subsequently separated 205 from said washing liquid (e.g., by precipitation). For example, the washing liquid may comprise an apolar solvent or a protic polar solvent or an aprotic polar solvent. At this stage, therefore, the ferromagnetic particles are coated with a nanometric functional coating comprising the first reagent, and are therefore electrostatically charged with said first charge. Moreover, the immersion 204 of the ferromagnetic particles in a washing liquid is such as to remove any excess reagent previously deposited during steps 201e 202. The deposition 101 of one or more nanometric functional coatings on the ferromagnetic particles further comprises immersing 206 the ferromagnetic particles in a second solution or suspension comprising a second reagent; according to one aspect of the present invention, the second reagent is such as to be characterized by a second electrostatic charge having a sign opposite to that of the first electrostatic charge of the first reagent.

As described above, for the purpose of optimizing the process of deposition of a coating of the second reagent on the surface of the ferromagnetic particles, the present invention may optionally comprise a step 207 wherein the ferromagnetic particles immersed in the second solution or suspension are stirred for a predetermined time period. The stirring process 207 can be carried out in accordance with the examples provided herein with reference to the stirring process 202. At the end of the stirring process 207, the particles are optionally separated 208 from the second solution, e.g., by centrifugation or by means of a static or rotating magnetic field, optionally immersed 209 in a washing liquid (e.g., deionized water, deionized water/ethanol mixtures, buffer, salt-containing aqueous solutions), and subsequently separated 210 from said washing liquid (e.g., by precipitation).

Steps 201-210 may be repeated a predetermined number of times as a function of the required number of functional coatings. The reagents in use may possibly differ among the various repetitions, permitting the creation of complex sequences of functional layers. Lastly, the ferromagnetic particles coated with one or more nanometric functional layers are subjected to drying.

As an alternative to or in combination with the above-described embodiment, the first and second reagents may have such polar characteristics as to allow the formation of hydrogen-bridge bonds and/or other van der Waals interactions. Such a type of bond can be established, for example, between components having, as functional groups, one or more of the following: hydroxyl group, carbonyl group or carboxylic group.

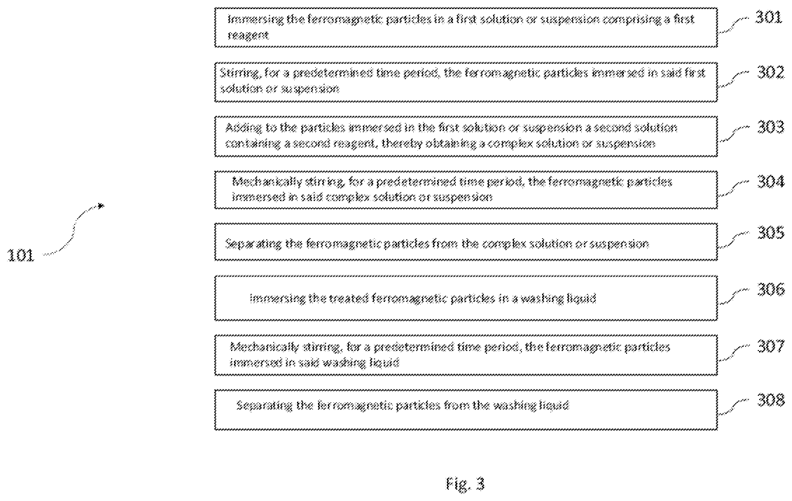

As shown in the block diagram of FIG. 3, step 101 may, as an alternative to or in combination with the previously described embodiments, be carried out by executing the following steps:
immersing the ferromagnetic particles in a first solution or suspension comprising a first reagent 301;
mechanically stirring, for a predetermined time period, the ferromagnetic particles immersed in said first solution or suspension 302;
immersing the ferromagnetic particles in a second solution or suspension comprising a second reagent 301; said step 301 may be carried out by adding to the particles immersed in the first solution or suspension a second solution containing a second reagent, thereby obtaining a complex solution or suspension 303;
mechanically stirring, for a predetermined time period, the ferromagnetic particles immersed in said complex solution or suspension 304;
separating the ferromagnetic particles from the complex solution or suspension 305;
immersing the treated ferromagnetic particles in a washing liquid 306.
mechanically stirring, for a predetermined time period, the ferromagnetic particles immersed in said washing liquid 307;
separating the ferromagnetic particles from the washing liquid 308.

Steps 301-308 may be repeated a predetermined number of times as a function of the required coating thickness. Steps 306 to 308 are optional. The reagents in use may possibly differ among the various repetitions, permitting the creation of complex sequences of functional layers. Lastly, the ferromagnetic particles coated with one or more functional layers are subjected to drying.

According to one aspect of the present invention, step 101 permits depositing, on the initial ferromagnetic particles, thin coatings (i.e., coatings having a thickness ranging from a few tens of nanometers to a few micrometers) characterized by excellent versatility in terms of composition and functionality. Step 101 envisages one or more cyclic runs of adsorption of the selected reagents (i.e., the first and second reagents) from an aqueous solution or suspension. During the deposition, the ferromagnetic particles are cyclically exposed to suspensions or solutions containing a first reagent and a second reagent (e.g., nanoparticles and/or polyelectrolytes) having opposite electrostatic charges. The immersion of the ferromagnetic particles in the suspension or solution makes it possible to deposit a thin layer of the selected reagent (i.e., the first and/or second reagent). By alternating reagents having opposite electrostatic charges, it is thus possible to build a coating on each ferromagnetic particle, the thickness of which can be controlled by the number of deposition cycles. The process of step 101 allows many degrees of freedom as to the process conditions and the reagents that can be employed. As a matter of fact, by modifying the following deposition parameters it is possible to control the final properties of the coating of the ferromagnetic particles (e.g., the thickness of the coatings of the first and/or second reagents):
the solvent in use (e.g., water, organic solvents, mixtures with polar solvents, etc.);
the times of immersion of the ferromagnetic particles in the first and second solutions and/or suspensions;
the concentration of the first and second solutions and/or suspensions;
the process temperature;
the pH of the solutions;
the ionic force of the solutions.

The first and second solutions and/or suspensions may comprise, without limitation, the following reagents in any form and combination thereof, depending on the desired final properties of the ferromagnetic material:
organic and inorganic synthetic polyelectrolytes (e.g., polyacrylic acid, polyamines, polyphosphates, etc.);
natural polyelectrolytes (e.g., chitosan, alginates, starch, etc.);
nanoparticles with various aspect ratios (e.g., nanoparticles of oxides or metals, nanolamellae of montmorillonite or graphenes, sepiolite fibers or carbon nanotubes, etc.).

As will be described in more detail in the remaining part of the present description, the ferromagnetic particles coated during step 101 are then treated, at step 102, using powder metallurgy techniques in order to obtain a compact, magnetically isotropic or, alternatively, magnetically anisotropic material having high volumetric electric resistivity.

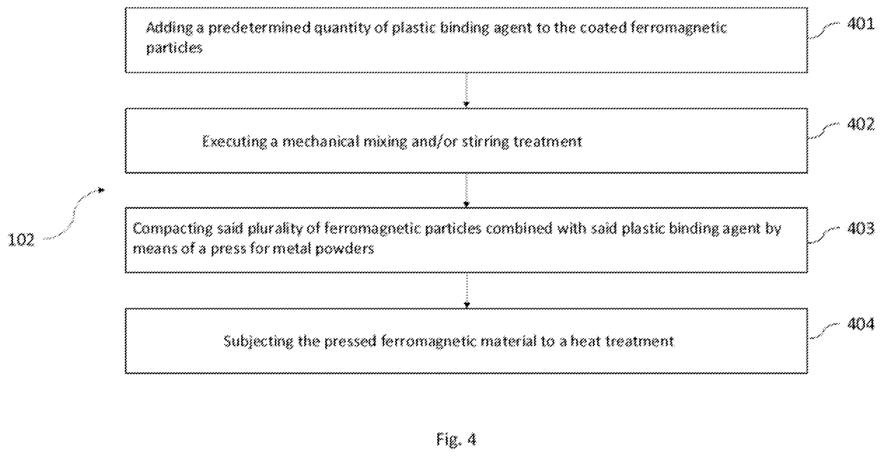

FIG. 4 shows one embodiment of step 102 wherein the ferromagnetic particles coated during step 101 are consolidated to obtain the ferromagnetic material in its final or intermediate form. At step 401, a predetermined quantity of binding agent (e.g., a polymeric, metallic, composite or ceramic binding agent) can be added to the coated ferromagnetic particles; the compound can subsequently be poured into a sealed container, in which a mechanical mixing treatment 402 will be executed. However, the coating itself may act as a lubricant, thus performing some functions of a plastic binding agent. Alternatively, the mechanical mixing and/or stirring may be carried out through the use of specific mills or mechanical treatments or other types of treatments known in the art. At step 403, the mixture comprising the ferromagnetic particles and any binding agent is compacted (i.e., consolidated) either at room temperature or in a heated mould by means of a press for metal powders (e.g., a double-punch press, possibly equipped with a magnetic powder alignment system), until the required density is attained. By way of example, the pressures adopted for compacting the coated ferromagnetic powders may reach values as high as 1,000 MPa. At step 404, the samples of pressed ferromagnetic material are optionally subjected to heat treatment at various temperatures, which depend on the type of binding/insulating agent in use (for example, without limitation, within a temperature range of 150° C. to 600° C.). Lastly, the ferromagnetic material thus obtained can be machined to be given its final shape.

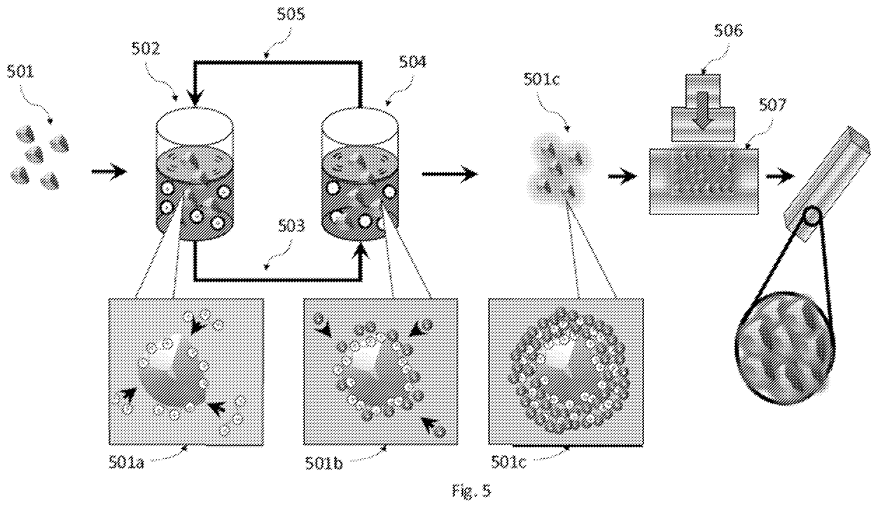

FIG. 5 schematically shows an exemplary embodiment of the method 100 for the production of a ferromagnetic material according to the present invention. Reference numeral 501 designates a plurality of ferromagnetic particles, which are immersed in a first solution and/or suspension 502 comprising a first reagent having a first charge. For example, the first reagent may comprise branched polyethylenimine, characterized by a positive electrostatic charge. When stirred, the ferromagnetic particles 501a immersed in the first solution and/or suspension are coated with a branched polyethylenimine coating characterized by a positive electrostatic charge. According to one aspect of the present invention, after a washing step 503 executed by using, for example, deionized water, the ferromagnetic particles 501a are immersed in a second solution and/or suspension 504 comprising, for example, colloidal silica characterized by a negative electrostatic charge. The ferromagnetic particles 501b are thus coated with a colloidal silica coating characterized by a negative electrostatic charge. The cycle of immersions in the first and second solutions and/or suspensions (alternated with washing steps 503, 505) can be repeated a predetermined number of times as a function of the required number of coatings. The process depicted by way of example in FIG. 5 shows the result of two cycles of immersions of the ferromagnetic particles in the first and second solutions and/or suspensions; at the end of the immersion cycles, the ferromagnetic particles 501c have two branched polyethylenimine coatings alternated with two colloidal silica coatings. The coated ferromagnetic particles 501c may be enriched with a plastic binding agent and/or with lubricating substances and subsequently mixed and/or stirred mechanically; finally, the ferromagnetic particles 501c are subjected to a consolidating and forming process by means of a metal powder press 506, producing the finished ferromagnetic material 507.

The method 100 for the production of a ferromagnetic material according to the present invention can be applied successfully regardless of the type of powder in use. For example, the ferromagnetic particles may consist of highly pure iron, iron alloys or compounds, and other elements in variable percentages (e.g., silicon, nickel, phosphorus, aluminium), amorphous materials (e.g., magnetic oxides of iron and other elements), alloys with a high coercive field (e.g., neodymium-iron-boron). The ferromagnetic powders may have irregular or regular (e.g., spherical) shapes, and a size preferably not smaller than 1 μm.

The ferromagnetic material obtained by means of the method 100 according to the present invention has innovative characteristics compared with the ferromagnetic materials that could be obtained by using prior-art methods.

The method 100 for the production of a ferromagnetic material according to the present invention offers several advantages over prior-art techniques. In particular, the deposition of one or more nanometric layers of materials of different nature on the single ferromagnetic particles gives the final product higher uniformity in comparison with the materials obtained by means of prior-art mechanical mixing methods. According to one aspect of the present invention, it is also possible to deposit organic or inorganic reagents, or both types of reagents alternated, on the single ferromagnetic particles. The deposition of nanometric coatings (whether of the organic or alternated organic-inorganic type) on the single ferromagnetic particles permits the formation of insulating layers characterized by a high coverage factor; this feature, which is a peculiarity of individually coated particles, is surprisingly reflected in the finished product (i.e., the ferromagnetic material obtained after consolidating the coated ferromagnetic particles), which has very low parasite currents.

In addition, the present invention permits raising the temperature of treatment of the ferromagnetic materials made in accordance with the present invention using organic binding agents. It is known that ferromagnetic materials obtained in accordance with prior-art techniques through the use of organic binding agents suffer from a sharp drop in their intergranular electric insulation when they are subjected to high temperatures (e.g., 200 to 300° C. for epoxy and phenolic resins); this phenomenon is caused by the formation of electric bridges between the ferromagnetic particles. The ferromagnetic materials obtained through the use of organic binding agents in accordance with the present invention surprisingly show an almost constant electric resistivity even at temperatures comparable with those of degradation of the organic insulating agent itself (e.g., within a temperature range of 300 to 400° C.). The higher maximum annealing temperature allows relieving the stresses induced in the ferromagnetic powder during the process (especially during the pressing operation), resulting in a reduction of the area of the hysteresis cycle up to 5% compared with non-annealed material. This effect is normally negligible at temperatures below 250-300° C.

Depending on the formulation of the coating made in accordance with the present invention, it is additionally possible to obtain a lubricating effect, which is favourably reflected in a higher final density of the compacted material, the pressure being equal, and in the pieces being more easily removable from the mould, which may also lead to reduced wear of the walls of the latter.

The method for the production of a ferromagnetic material described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above-described method for the production of a ferromagnetic material, but may be subject to many modifications, improvements or replacements of equivalent parts and elements without departing from the inventive idea, as clearly specified in the following claims.

1. A method for the production of a ferromagnetic material, comprising the following steps:
depositing one or more nanometric functional coatings on a plurality of ferromagnetic particles;
consolidating said plurality of coated ferromagnetic particles to obtain said ferromagnetic material;
characterized in that said step of depositing one or more functional coatings comprises the following steps:
exposing, by immersion, said plurality of ferromagnetic particles to a first solution or suspension comprising a first reagent;
exposing, by immersion, said plurality of ferromagnetic particles to a second solution or suspension comprising a second reagent;
said first and second reagents being characterized by opposite electrostatic charges and/or having such polar characteristics as to allow the formation of hydrogen-bridge bonds and/or other van der Waals interactions.

2. The method for the production of a ferromagnetic material according to claim 1, wherein said step of depositing one or more functional coatings further comprises the following steps:
stirring, for a predetermined time period, said plurality of ferromagnetic particles immersed in said first solution or suspension;
separating the ferromagnetic particles from said first solution or suspension and immersing said plurality of ferromagnetic particles in a washing liquid;
separating the ferromagnetic particles from said washing liquid.

3. The method for the production of a ferromagnetic material according to claim 2, wherein said step of stirring is carried out by mechanical stirring.

4. The method for the production of a ferromagnetic material according to claim 3, wherein said mechanical stirring is carried out by means of a turbulent mixer.

5. The method for the production of a ferromagnetic material according to claim 2, wherein said step of stirring is carried out by means of a rotating magnetic field.

6. The method for the production of a ferromagnetic material according to claim 2, wherein said step of stirring is carried out by means of ultrasounds.

7. The method for the production of a ferromagnetic material according to claim 2, wherein said washing liquid comprises an apolar solvent or a protic polar solvent or an aprotic polar solvent.

8. The method for the production of a ferromagnetic material according to claim 1, wherein said first reagent comprises a polyelectrolyte or nanoparticles, and wherein said first electrostatic charge has a positive sign.

9. The method for the production of a ferromagnetic material according to claim 1, wherein said first electrostatic charge has a negative sign.

10. The method for the production of a ferromagnetic material according to claim 8, wherein said second reagent comprises a polyelectrolyte or nanoparticles, and wherein said second electrostatic charge has a negative sign.

11. The method for the production of a ferromagnetic material according to claim 9, wherein said second electrostatic charge has a positive sign.

12. The method for the production of a ferromagnetic material according to claim 1, wherein said step of depositing one or more nanometric functional coatings is repeated a predetermined number of times as a function of a predetermined number of functional coatings.

13. The method for the production of a ferromagnetic material according to claim 1, wherein said step of consolidating said plurality of ferromagnetic particles comprises the step of compacting said plurality of ferromagnetic particles by means of a metal powder press.

14. The method for the production of a ferromagnetic material according to claim 1, wherein said step of consolidating said plurality of ferromagnetic particles comprises the step of stirring and/or mixing said plurality of ferromagnetic particles.

15. The method for the production of a ferromagnetic material according to claim 14, wherein said step of stirring is carried out by mechanical stirring.

16. The method for the production of a ferromagnetic material according to claim 15, wherein said mechanical stirring is carried out by means of a turbulent mixer.

17. The method for the production of a ferromagnetic material according to claim 14, wherein said step of stirring is carried out by means of a rotating magnetic field.

18. The method for the production of a ferromagnetic material according to claim 14, wherein said step of stirring is carried out by means of ultrasounds.

19. The method for the production of a ferromagnetic material according to claim 1, wherein said first solution or suspension comprises one or more organic components.

20. The method for the production of a ferromagnetic material according to claim 1, wherein said first solution or suspension comprises one or more inorganic components.

21. The method for the production of a ferromagnetic material according to claim 1, wherein said surface coating deposited on the particles has a thickness in the range of 1 nm to 100 micron.

22. A ferromagnetic material produced by using the method for the production of a ferromagnetic material according to claim 1.
